(19) United States
(12) Patent Application Publication
(10) Pub. No.: US 2012/0059097 A1
(43) Pub. Date: Mar. 8, 2012

(54) STARCH-BASED THERMOPLASTIC COMPOSITES

(75) Inventors: Sheng-Ju Liao, Hsinchu City (TW); Chien-Ming Chen, Taoyuan County (TW); Chih-Jen Chang, Miaoli County (TW); Yao-Chu Chung, Kaohsiung City (TW); Cheng-Feng Liao, Pingtung County (TW); Hsieh-Yung Chang, Taoyuan County (TW)

(73) Assignee: INDUSTRIAL TECHNOLOGY RESEARCH INSTITUTE, Hsinchu County (TW)

(21) Appl. No.: 13/040,266

(22) Filed: Mar. 4, 2011

(30) Foreign Application Priority Data
Sep. 6, 2010 (TW) 099130013

(51) Int. Cl. C08L 3/00; C08K 5/1539; C08K 5/101

(52) U.S. Cl. 524/112; 525/54.26; 524/502; 524/315

(57) ABSTRACT

In an embodiment, a starch-based thermoplastic composite is provided. The starch-based thermoplastic composite includes thermoplastic starch (TPS), polycarbonate (PC) and acrylonitrile butadiene styrene (ABS), wherein the polycarbonate has a weight ratio of 15-60% in the starch-based thermoplastic composite. The starch-based thermoplastic composite further includes an impact modifier and a compatibilizer.

### CROSS REFERENCE TO RELATED APPLICATIONS

This application claims priority of Taiwan Patent Application No. 99130013, filed on Sep. 6, 2010, the entirety of which is incorporated by reference herein.

### BACKGROUND OF THE INVENTION

1. Field of the Invention

The invention relates to a thermoplastic composite, and in particular to a starch-based thermoplastic composite containing thermoplastic starch.

2. Description of the Related Art

Generally, the thermal stability of materials from a biomass is low. When they are blended and processed with petrochemical engineering plastics, due to poor compatibility and large differences in melt viscosities therebetween, some phenomena, for example uneven distribution, stratification and aggregation occur, such that melt processing cannot be conducted.

The hydrogen bond of starch is destroyed by conducting plasticizers, for example polyols, then, in the starch molecule, chain entanglement and chain motion occur, achieving thermal plasticization characteristics. Thermoplastic starch (TPS), as other synthetic polymers with fluidic characteristics, is applicable to be used for thermoplastic molding and extrusion processing technology. However, lack of mechanical strength, pure thermoplastic starch materials have limited applications. Therefore, a follow-up blending system has been developed.

The market share of ICT products of Taiwan is high in global, for example, the global shipment of personal computers reached 313 million units in 2010, with a growth rate of 9.32%. With personal and mobile broadband internet era, impelling NB and mobile phone markets to continuously grow, the global shipment of Note-PC increased to 185 million units in 2010, with a growth rate of 21.71%, while the mobile phone market is expected to reach 1.589 billion units, with an annual growth rate of 11.9%. Overall, the continuous growth of ICT products promotes the demands for their housing materials, so the ICT industry has a strong demand for green and recycled materials which can reduce carbon emission.

If new environmental protection materials consistent with EPA EPEAT green purchasing specifications (biomass content exceeding 10%) or Japan Bioplastics Association (JBPA) BiomassPla mark (Biomass content exceeding 25%) can be developed, 15 to 40 million tons of plastic or plastic-related materials consumption of petrochemical materials can be reduced per year.

### BRIEF SUMMARY OF THE INVENTION

One embodiment of the invention provides a starch-based thermoplastic composite, comprising: thermoplastic starch (TPS); polycarbonate (PC), wherein the polycarbonate has a weight ratio of 15-60% in the starch-based thermoplastic composite; and acrylonitrile butadiene styrene (ABS).

In an embodiment of the invention, the thermoplastic starch is an enzymatic degradable thermoplastic starch. The thermoplastic starch has a weight ratio of 10-70%, or preferably 10-35%, in the starch-based thermoplastic composite. 95% of the thermoplastic starch has a particle size less than 1.5 μm.

In one embodiment, the polycarbonate has a weight ratio of 30-45% in the starch-based thermoplastic composite.

In another embodiment, the acrylonitrile butadiene styrene has a weight ratio of 15-60%, or preferably 30-45%, in the starch-based thermoplastic composite.

Still another embodiment, the starch-based thermoplastic composite further comprises an impact modifier. The impact modifier comprises metallocene-based polyethylene (MPE), polypropylene (PP), poly(butadiene-styrene) (PBS), thermoplastic polyurethane (TPU), styrene-ethylene/butylene-styrene (SEBS), styrene-ethylene/propylene-styrene (SEPS), methacrylated butadiene-styrene (MBS), thermoplastic elastomers (TPE), high-rubber content acrylonitrile butadiene styrene (ABS) or a combination thereof. The impact modifier has a weight ratio of 2-45%, or preferably 5-30%, in the starch-based thermoplastic composite.

The starch-based thermoplastic composite further comprises a compatibilizer. The compatibilizer comprises polyethylene-g-maleic anhydride (PE-g-MA), polyethylene-g-glycidyl methacrylate (PE-g-GMA), ethylenevinylacetate-g-maleic anhydride (EVA-g-MA), polypropylene-g-maleic anhydride (PP-g-MA), polystyrene-g-maleic anhydride (PS-g-MA), acrylonitrile butadiene styrene-g-maleic anhydride (ABS-g-MA), styrene maleic anhydride (SMA) or a combination thereof. The compatibilizer has a weight ratio of 0.1-20%, or preferably 3-7%, in the starch-based thermoplastic composite.

The invention utilizes controlled end-cap technology comprising starch debranching degradation and functional group modification to give starch some properties, for example rheological processability and low moisture absorption, then utilizes the compatible interface structure formed thereof, reinforced structure and thermal stability mechanism to address long-standing issues, for example the compatibility, processability and degradation between biomass materials and petrochemical materials. Commercially available plastic parts which mainly comprise petrochemical engineering plastics, for example high impact polystyrene (HIPS), acrylonitrile butadiene styrene (ABS) and polycarbonate/acrylonitrile butadiene styrene (PC/ABS), of ICT housing products can be replaced by the developed high-efficiency starch-based biomass composite with a starch content exceeding 25% and a heat deflection temperature (HDT) exceeding 85° C.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawing, wherein:

FIGS. 1a-1d exhibit size and shape of starch in the starch-based biomass composite of the invention;

FIG. 2 shows a relationship between compactness and particle size of starch in the starch-based biomass composite of the invention;

FIG. 3 shows a cosmetics case fabricated by the starch-based biomass composite of the invention;

FIG. 4 shows a cartridge case fabricated by the starch-based biomass composite of the invention;

FIG. 5 shows a thick phone case fabricated by the starch-based biomass composite of the invention; and

FIG. 6 shows a twinshot phone case fabricated by the starch-based biomass composite of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

One embodiment of the invention provides a starch-based thermoplastic composite comprising thermoplastic starch (TPS), polycarbonate (PC) and acrylonitrile butadiene styrene (ABS). Specifically, the polycarbonate has a weight ratio of 15-60%, or preferably 30-45%, in the disclosed starch-based thermoplastic composite.

The thermoplastic starch may be enzymatic degradable thermoplastic starch. The original starch structure with high-density branch chains and high end-crystallization is decomposed utilizing a specific enzyme to cut the α-1,6 bonding of the branch chains to form the thermoplastic starch with chain entanglement and plasticity property. The thermoplastic starch has a weight ratio of 10-70%, or preferably 10-35%, for example exceeding or equal to 25%, in the disclosed starch-based thermoplastic composite. 95% of the thermoplastic starch has a particle size less than 1.5 μm.

The invention selects polyols having solubility similar to starch, water, high-temperature resistant natural plasticizers to prepare a complex formulation with starch. After granulation, thermoplastic starch particles are therefore prepared. The melt viscosity of the thermoplastic starch is adjustable by altering the plasticizers and their contents.

The acrylonitrile butadiene styrene has a weight ratio of 15-60%, or preferably 30-45%, in the disclosed starch-based thermoplastic composite.

The disclosed starch-based thermoplastic composite further comprises an impact modifier, for example metallocene-based polyethylene (MPE), polypropylene (PP), poly(butadiene-styrene) (PBS), thermoplastic polyurethane (TPU), styrene-ethylene/butylene-styrene (SEBS), styrene-ethylene/propylene-styrene (SEPS), methacrylated butadiene-styrene (MBS), thermoplastic elastomers (TPE), high-rubber content acrylonitrile butadiene styrene (ABS) or a combination thereof. The impact modifier has a weight ratio of 2-45%, or preferably 5-30%, in the disclosed starch-based thermoplastic composite.

The invention optionally includes the impact modifier compatible with the polymer substrate and starch to improve the toughness of the substrate. Also, due to the improved capacity by the impact modifier, after optimally adjusting of the composition, the physical properties of the composite were improved.

A preferred impact modifier of the invention is one compatible with the polymer substrate and capable of reaction with hydroxy group (—OH) on the starch surface to reduce interfacial tension, thereby improving the physical properties of the composite.

The disclosed starch-based thermoplastic composite can further comprise a compatibilizer, for example polyethylene-g-maleic anhydride (PE-g-MA), polyethylene-g-glycidyl methacrylate (PE-g-GMA), ethylenevinylacetate-g-maleic anhydride (EVA-g-MA), polypropylene-g-maleic anhydride (PP-g-MA), polystyrene-g-maleic anhydride (PS-g-MA), acrylonitrile butadiene styrene-g-maleic anhydride (ABS-g-MA), styrene maleic anhydride (SMA) or a combination thereof. The compatibilizer has a weight ratio of 0.1-20%, or preferably 3-7%, in the disclosed starch-based thermoplastic composite.

The invention utilizes controlled end-cap technology comprising starch debranching degradation and functional group modification to give starch some properties, for example rheological processability and low moisture absorption, then utilizes the compatible interface structure formed thereof, reinforced structure and thermal stability mechanism to address long-standing issues, for example the compatibility, processability and degradation between biomass materials and petrochemical materials. Commercially available plastic parts which mainly comprise petrochemical engineering plastics, for example high impact polystyrene (HIPS), acrylonitrile butadiene styrene (ABS) and polycarbonate/acrylonitrile butadiene styrene (PC/ABS), of ICT housing products can be replaced by the developed high-efficiency starch-based biomass composite with a starch content exceeding 25% and a heat deflection temperature (HDT) exceeding 85° C.

### Example 1

Analysis of Physical Properties of the Starch-Based Thermoplastic Composite (1)

Polycarbonate (PC, purchased from Mitsubishi Corporation, model: H3000) was utilized as an impact modifier for a thermoplastic starch (TPS)/acrylonitrile butadiene styrene (ABS) biomass composite system (TPS was prepared by the method in TW Pat. No. 1283167 “The preparation of enzymatic degradable starch and applications thereof”, and ABS was purchased from Grand Pacific Petrochemical Corporation, model: D100). Melt blending was performed in a twin screw extruder under a processing temperature of 227° C. and a screw rotation speed of 100 rpm to prepare TPS/(PC/ABS) particles. The viscosity of the system can be effectively reduced by adding TPS. The extrusion strip with a smooth surface and improved toughness exhibited a light yellow color.

The analysis of the physical properties of the TPS/ABS biomass composite system containing the PC impact modifier with various ratios are shown in Table 1. Physical properties comprise impact resistance, thermal deformation resistance and mobility. The results indicate that the mechanical properties, for example impact strength (the notched specimen and un-notched specimen were respectively utilized), tensile strength (TS), elongation, flexural strength (FS), flexural modules (FM) and heat deflection temperature (HDT), of the PC/TPS/ABS biomass composite were apparently improved. After PC was conducted, the mobility, for example melt index (MI), of the biomass composite was also apparently improved; which is suitable for use in forming of thin injection products.

TABLE 1

| Mechanical properties | AT-54 | PAT-06 | PAT-05 | PAT-04 |
|---|---|---|---|---|
| TPS content | 25% | 25% | 25% | 25% |
| PC content | 0% | 15% | 30% | 45% |
| ABS content | 70% | 60% | 45% | 30% |
| Impact strength | 10.81 | 6.5 | 11.4 | 9.6 |
| (notched | | | | |
| specimen) | | | | |
| (kgf-cm/cm) | | | | |
| Impact strength | — | 127 | 164 | 183 |
| (un-notched | | | | |
| specimen) | | | | |
| (kgf-cm/cm) | | | | |
| Tensile strength | 297 | 356 | 384 | 420 |
| (TS) (kgf/cm²) | | | | |
| Elongation (%) | 2.5 | 11 | 12 | 18 |
| Flexural strength | 392 | 556 | 618 | 694 |
| (FS) (kgf/cm²) | | | | |
| Flexural modules | 15604 | 19048 | 20368 | 21728 |
| (FM) (kgf-cm/cm) | | | | |
| Heat deflection | 74 | 70 | 85 | 97 |
| temperature | | | | |
| (HDT) | | | | |
| (° C./264 psi) | | | | |
| Melt index (MI) | 0.05* | 22 | 21 | 22 |
| (g/10 min, | | | | |
| 230° C., 5 kg) | | | | |

*MI test condition: g/10 min, 200° C., 5 kg

### Example 2

Analysis of Physical Properties of the Starch-Based Thermoplastic Composite (2)

S-grade PC (purchased from Mitsubishi Corporation, model: S3000) and H-grade PC (purchased from Mitsubishi Corporation, model: H3000) were respectively added to a TPS/ABS biomass composite system (TPS was prepared by the method in TW Pat. No. I283167 “The preparation of enzymatic degradable starch and applications thereof”, and ABS was purchased from Grand Pacific Petrochemical Corporation, model: D100). The results shown in Table 2 indicate that the impact strength and rigidity of the biomass composite were improved by adding S-grade PC. Particularly, the impact strength of PAT-37 achieved 18.13 kgf-cm/cm and the heat deflection temperature thereof achieved 101° C. The high-efficiency starch-based biomass composite is suitable for use in plastic parts of ICT housing products.

TABLE 2

| Mechanical properties | PAT-05 | PAT-04 | PAT-33 | PAT-37 |
|---|---|---|---|---|
| TPS content | 25% | 25% | 25% | 25% |
| PC content | 30% | 45% | 30% | 45% |
| ABS content | 45% | 30% | 45% | 30% |
| PC grade | H | H | S | S |
| Impact strength | 11.4 | 9.6 | 12.34 | 18.13 |
| (notched | | | | |
| specimen) | | | | |
| (kgf-cm/cm) | | | | |
| Tensile strength | 384 | 420 | 411 | 475 |
| (TS) (kgf/cm²) | | | | |
| Elongation | 12 | 18 | 5 | 9 |
| (%) | | | | |
| Flexural strength | 618 | 694 | 616 | 745 |
| (FS) (kgf/cm²) | | | | |
| Flexural modules | 20368 | 21728 | 21122 | 23732 |
| (FM) (kgf-cm/cm) | | | | |
| Heat deflection | 85 | 97 | 86 | 101 |
| temperature | | | | |
| (HDT) | | | | |
| (° C./264 psi) | | | | |
| Melt index (MI) | 21 | 22 | 10 | 11 |
| (g/10 min, | | | | |
| 230° C., 5 kg) | | | | |

### Example 3

Starch Distribution Profile in the Starch-Based Thermoplastic Composite

PC (purchased from Mitsubishi Corporation, model: S3000) was utilized as an impact modifier for a TPS/ABS biomass composite system (TPS was prepared by the method in TW Pat. No. I283167 “The preparation of enzymatic degradable starch and applications thereof”, and ABS was purchased from Grand Pacific Petrochemical Corporation, model: D100). Various ratios (25%, 35%, 50% and 70%) of TPS and PC/ABS were added and melt-blended in a twin screw extruder under a processing temperature of 190-230° C. and a screw rotation speed of 50-200 rpm to prepare a 70% TPS/(PC/ABS) biomass composite masterbatch.

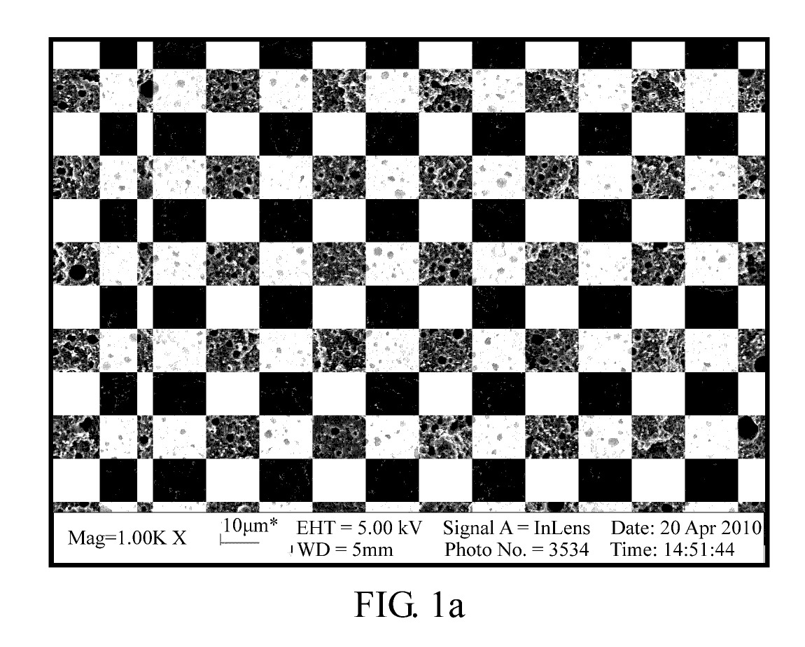

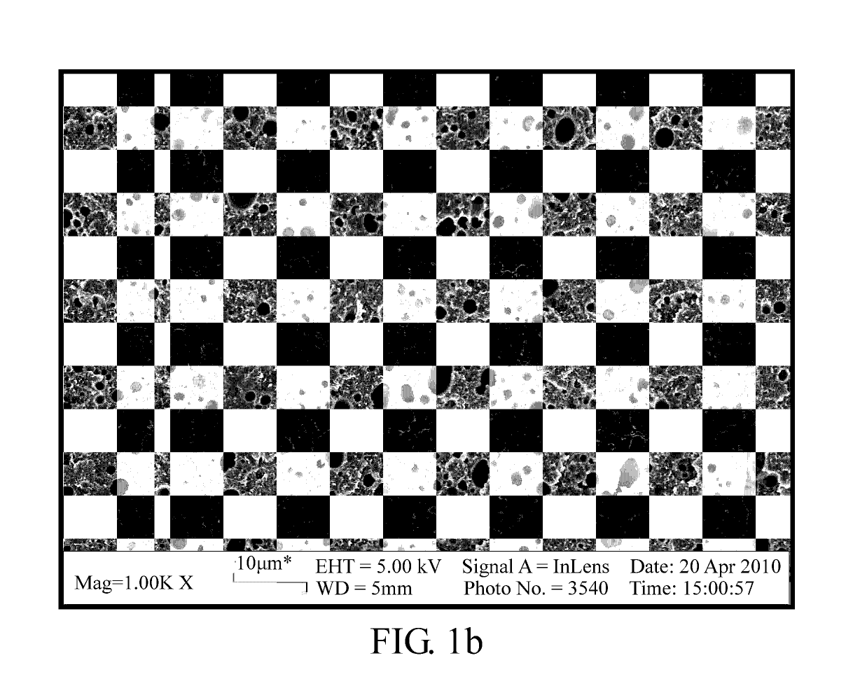

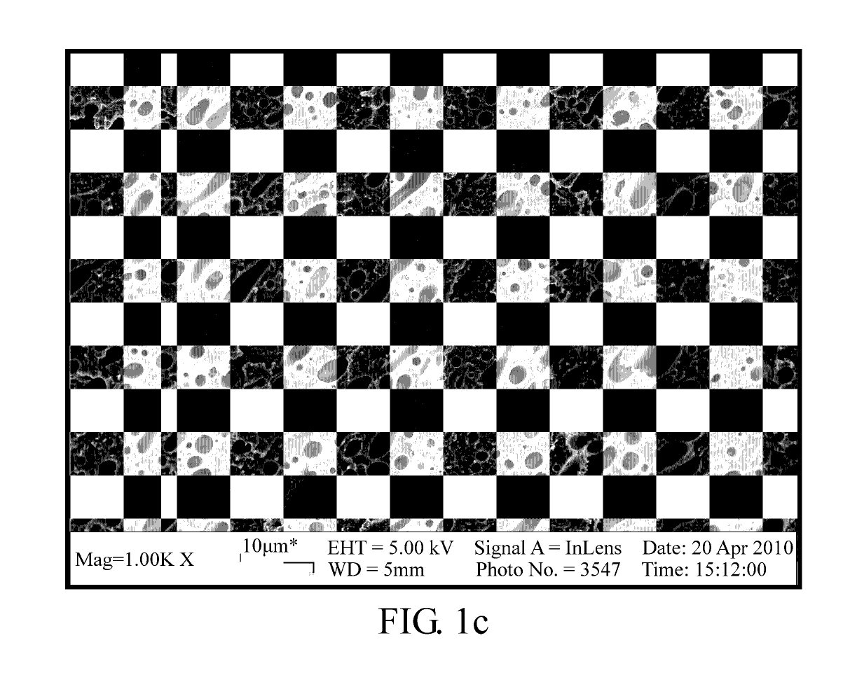

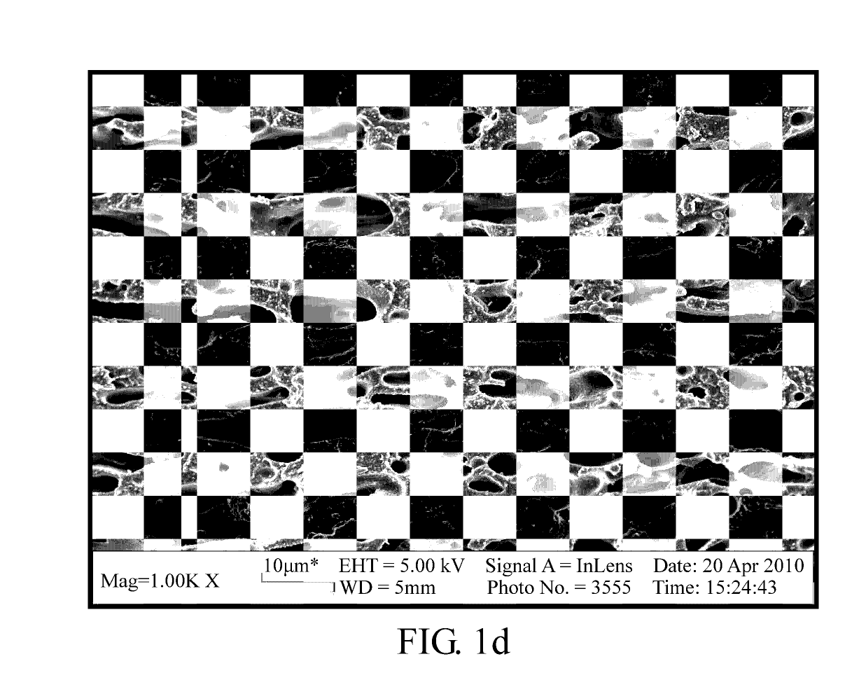

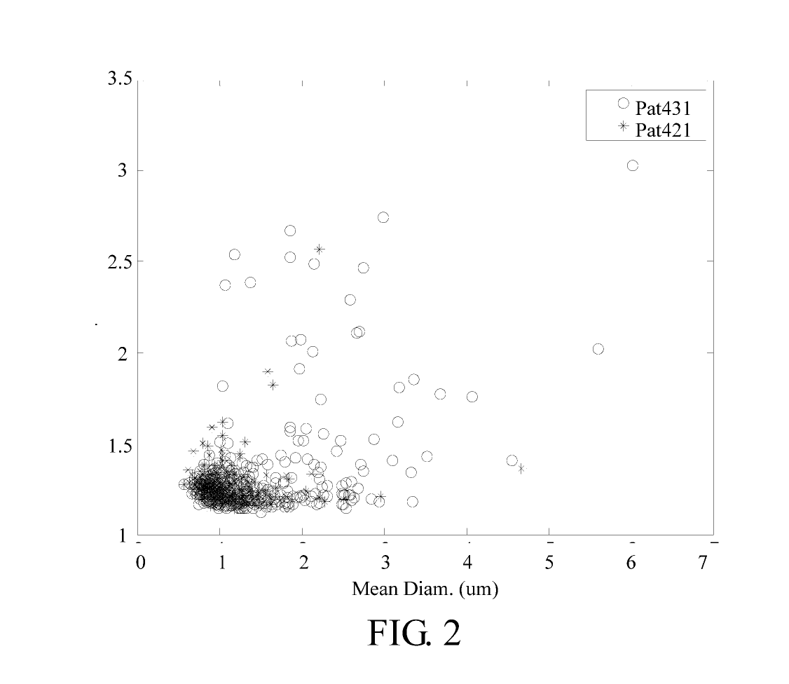

The SEM analytic results respectively shown in FIG. 1a (25% TPS), FIG. 1b (35% TPS), FIG. 1c (50% TPS) and FIG. 1d (70% TPS) indicate that as the TPS content was increased, the domain size thereof was increased due to aggregation, while altering from a circle to a long and narrow shape. When the TPS content was increased to 70%, a co-continuous phase was formed. Additionally, FIG. 2 shows that when the particle size of the starch in the TPS/(PC/ABS) composite was small and close to a circular shape, the impact strength of the composite was effectively improved. For example, the impact strength of Pat431 composite (containing 35% TPS) was 4.3 kgf-cm/cm, however, the impact strength of Pat421 composite (containing 25% TPS) was substantially increased to 18.1 kgf-cm/cm due to smaller TPS particles and a shape being much closer to circular shape. The particle size of 95% TPS was less than 1.5 μm.

### Example 4

Injection Products of the Starch-Based Thermoplastic Composite

The high-efficiency starch-based biomass composite was injected from an injection molding machine with a processing temperature of 190-230° C. to form various prototyping products. The possibility of applications on housing materials of electronic and peripheral devices was validated in Table 3. High impact polystyrene (HIPS) was purchased from Chi Mei Corporation (model: PH-88-S). ABS was purchased from Grand Pacific Petrochemical Corporation (model: D100). PC was purchased from Mitsubishi Corporation (model: S3000).

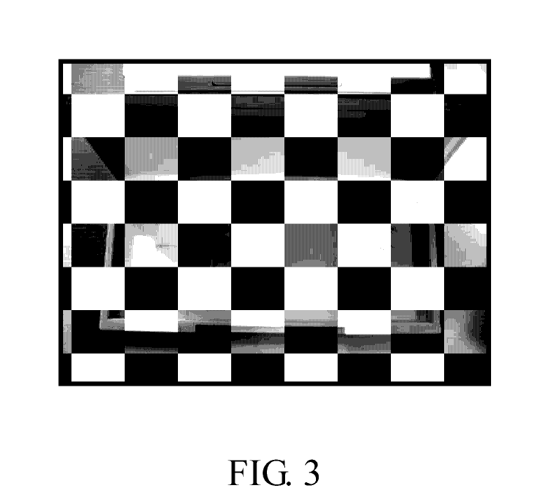

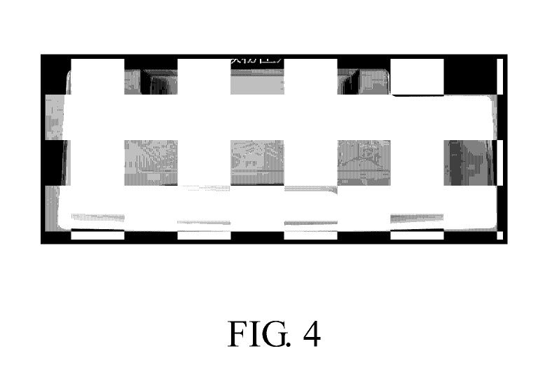

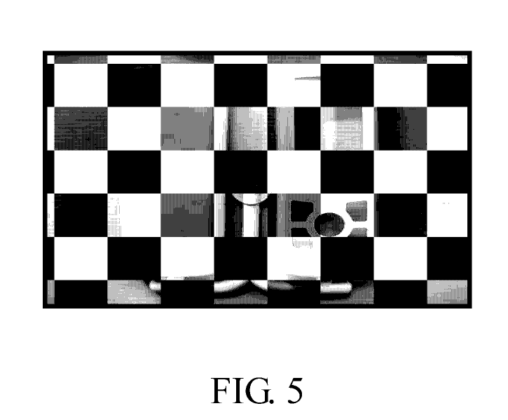

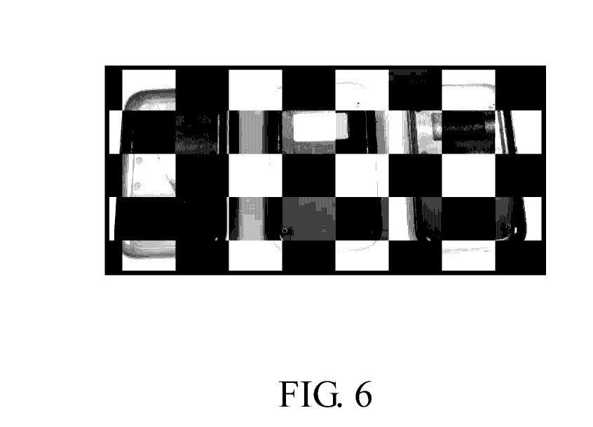

TABLE 3

| | | | ABS-54 | |
|---|---|---|---|---|
| | | | (Thick phone | PAT-37 |
| | ST-01 | ABS-06 | case, as | (Twinshot |
| | (Cosmetics | (Cartridge | shown in | phone case, |
| | case, as | case, as | FIG. 5) | as shown in |
| Mechanical | shown in | shown in | (1.2 mm- | FIG. 6) |
| properties | FIG. 3) | FIG. 4) | 2.2 mm) | (0.7 mm) |
| TPS content | 30% | 25% | 25% | 25% |
| Polymer matrix | HIPS | ABS | ABS | PC/ABS |
| Impact strength | 5.64 | 4.33 | 10.81 | 18.13 |
| (kgf-cm/cm) | | | | |
| Tensile strength | 158 | 299 | 297 | 475 |
| (TS) (kgf/cm²) | | | | |
| Elongation (%) | 2.7 | 20.0 | 2.5 | 9 |
| Flexural strength | 287 | — | 392 | 745 |
| (FS) (kgf/cm²) | | | | |
| Flexural modules | 18582 | — | 15604 | 23732 |
| (FM) | | | | |
| (kgf-cm/cm) | | | | |
| Heat deflection | 67 | — | 74 | 101 |
| temperature | | | | |
| (HDT) | | | | |
| (° C./264 psi) | | | | |
| Melt index (MI) | — | — | 0.05 | 11 |
| (g/10 min, | | | | |
| 230° C., 5 kg) | | | | |

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A starch-based thermoplastic composite, comprising:
thermoplastic starch (TPS);
polycarbonate (PC), wherein the polycarbonate has a weight ratio of 15-60% in the starch-based thermoplastic composite; and
acrylonitrile butadiene styrene (ABS).

2. The starch-based thermoplastic composite as claimed in claim 1, wherein the thermoplastic starch is an enzymatic degradable thermoplastic starch.

3. The starch-based thermoplastic composite as claimed in claim 1, wherein the thermoplastic starch has a weight ratio of 10-70% in the starch-based thermoplastic composite.

4. The starch-based thermoplastic composite as claimed in claim 1, wherein the thermoplastic starch has a weight ratio of 10-35% in the starch-based thermoplastic composite.

5. The starch-based thermoplastic composite as claimed in claim 1, wherein 95% of the thermoplastic starch has a particle size less than 1.5 μm.

6. The starch-based thermoplastic composite as claimed in claim 1, wherein the polycarbonate has a weight ratio of 30-45% in the starch-based thermoplastic composite.

7. The starch-based thermoplastic composite as claimed in claim 1, wherein the acrylonitrile butadiene styrene has a weight ratio of 15-60% in the starch-based thermoplastic composite.

8. The starch-based thermoplastic composite as claimed in claim 1, wherein the acrylonitrile butadiene styrene has a weight ratio of 30-45% in the starch-based thermoplastic composite.

9. The starch-based thermoplastic composite as claimed in claim 1, further comprising an impact modifier.

10. The starch-based thermoplastic composite as claimed in claim 9, wherein the impact modifier comprises metallocene-based polyethylene (MPE), polypropylene (PP), poly(butadiene-styrene) (PBS), thermoplastic polyurethane (TPU), styrene-ethylene/butylene-styrene (SEBS), styrene-ethylene/propylene-styrene (SEPS), methacrylated butadiene-styrene (MBS), thermoplastic elastomers (TPE), high-rubber content acrylonitrile butadiene styrene (ABS) or a combination thereof.

11. The starch-based thermoplastic composite as claimed in claim 9, wherein the impact modifier has a weight ratio of 2-45% in the starch-based thermoplastic composite.

12. The starch-based thermoplastic composite as claimed in claim 9, wherein the impact modifier has a weight ratio of 5-30% in the starch-based thermoplastic composite.

13. The starch-based thermoplastic composite as claimed in claim 1, further comprising a compatibilizer.

14. The starch-based thermoplastic composite as claimed in claim 13, wherein the compatibilizer comprises polyethylene-g-maleic anhydride (PE-g-MA), polyethylene-g-glycidyl methacrylate (PE-g-GMA), ethylenevinylacetate-g-maleic anhydride (EVA-g-MA), polypropylene-g-maleic anhydride (PP-g-MA), polystyrene-g-maleic anhydride (PS-g-MA), acrylonitrile butadiene styrene-g-maleic anhydride (ABS-g-MA), styrene maleic anhydride (SMA) or a combination thereof.

15. The starch-based thermoplastic composite as claimed in claim 13, wherein the compatibilizer has a weight ratio of 0.1-20% in the starch-based thermoplastic composite.

16. The starch-based thermoplastic composite as claimed in claim 13, wherein the compatibilizer has a weight ratio of 3-7% in the starch-based thermoplastic composite.
